(19) United States
(12) Patent Application Publication
(10) Pub. No.: US 2002/0174034 A1
(43) Pub. Date: Nov. 21, 2002

(54) Method and apparatus for a distributed web commerce system

(75) Inventors: Michael Kai-Yin Au, Markham (CA); Donald Alexander Bourne, Toronto (CA); Qi Cheng, North York (CA); Asit Dan, Pleasantville, NY (US); Daniel Manuel Dias, Moheqan Lake, NY (US); David Fletcher Evans, Waterloo (CA); Richard P. King, Scarsdale, NY (US); Ivan Lew, Toronto (CA); John F. Schumacher, White plains, NY (US); Hidayatullah H. Shaikh, Moheqan Lake, NY (US); Johnny Wai-Nang Wong, Waterloo (CA); Yanchun Zhao, Toronto (CA)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/859,705

(22) Filed: May 17, 2001

(51) Int. Cl. G06F 17/60

(52) U.S. Cl. 705/27

(57) ABSTRACT

A method, apparatus, and computer implemented instructions for processing commercial transactions of a user over a large geographic area. The system for processing commercial transactions includes a network, and one or more primary computing nodes connected to the network and a plurality of secondary computing nodes connected to the network in which each of the plurality of secondary computing nodes being associated with one of the plurality of geographic sites. The system also includes product inventories in which the product inventories are associated with one of the geographic sites. A catalog of products identifying the product inventories is present. One or more primary computing nodes notifies the secondary computing nodes of the catalog. A user contacts a first node from the plurality of secondary computing nodes. The user may purchase or place a product order with the first node with the “first node” forwarding the order to one or more primary computing nodes. The order is executed or completed at one or more primary computing nodes. The one or more primary computing nodes notifies the secondary computing nodes of the catalog, and updates to the catalog. The primary and secondary computing nodes exchange necessary information on shopping cart data, user information, and personalization information.

### BACKGROUND OF THE INVENTION

1. Technical Field

The present invention provides an improved data processing system, in particular a method and apparatus for facilitating electronic commerce. Still more particularly, the present invention provides a method, apparatus, and computer implemented instructions for a distributed Web commerce server system.

2. Description of Related Art

The Internet, also referred to as an “internetwork”, is a set of computer networks, possibly dissimilar, joined together by means of gateways that handle data transfer and the conversion of messages from the sending network to the receiving network (with packets if necessary) using network protocols. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transactions using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and businesses use the Web to purchase various goods and services. Some companies offer goods and services solely on the Web while others use the Web to extend their reach.

With respect to these commercial activities and others, businesses and other content providers employ servers to process requests from different users. Various architectures are employed in handling these requests. One architecture involves the use of a single server, while another employs a set of servers in a cluster or server farm to handle requests. A single server is often unable to handle the amount of requests involved with a successful electronic commerce business. More often, multiple servers in a cluster are employed. With this type of system, a catalog of items offered by the business on the Web site is stored in a database system. As traffic or business increases, the amount of computing resources may be increased through scaling. Scaling is typically provided by adding additional servers to the cluster. One drawback to this system is the use of a shared backend database. The throughput of this type of system is limited to the processing resources allocated to the shared database system.

Therefore, it would be advantageous to have an improved method and apparatus for providing a Web commerce server system.

### SUMMARY OF THE INVENTION

The present invention provides a method, apparatus, and computer implemented instructions for processing commercial transactions of a user over a large geographic area. The system for processing commercial transactions includes a network, and one or more primary computing nodes connected to the network and a plurality of secondary computing nodes connected to the network in which each of the plurality of secondary computing nodes being associated with one of the plurality of geographic sites. The system also includes product inventories in which the product inventories are associated with one of the geographic sites. A catalog of products identifying the product inventories is present. One or more primary computing nodes notifies the secondary computing nodes of the catalog. A user contacts a first node from the plurality of secondary computing nodes. The user may purchase or place a product order with the first node with the “first node” forwarding the order to one or more primary computing nodes. The order is executed or completed at one or more primary computing nodes. The one or more primary computing nodes notifies the secondary computing nodes of the catalog, and updates to the catalog. The primary and secondary computing nodes exchange necessary information on shopping cart data, user information, and personalization information.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a server cluster in accordance with a preferred embodiment of the present invention;

FIG. 3 is a block diagram of a data processing system that may be implemented as a server in accordance with a preferred embodiment of the present invention;

FIG. 4 is a diagram illustrating components used in a Web commerce server in accordance with a preferred embodiment of the present invention;

FIG. 5 is a Web commerce server system in accordance with a preferred embodiment of the present invention;

FIG. 6 is a flowchart of a process used for sending a catalog to a secondary server in accordance with a preferred embodiment of the present invention;

FIG. 7 is a flowchart of a process used for receiving a catalog at a secondary server in accordance with a preferred embodiment of the present invention;

FIG. 8 is a flowchart of a process used for allocating items to servers within a Web commerce server system in accordance with a preferred embodiment of the present invention;

FIG. 9 is a flowchart of a process used for receiving inventory allocations in accordance with a preferred embodiment of the present invention;

FIG. 10 is a flowchart of a process used for handling a customer request in accordance with a preferred embodiment of the present invention;

FIG. 11 is a flowchart of a process used for generating an inventory request in accordance with a preferred embodiment of the present invention;

FIG. 12 is a flowchart of a process used for handling a request for inventory in accordance with a preferred embodiment of the present invention;

FIG. 13, a flowchart of a process used for updating inventory at a server is depicted in accordance with a preferred embodiment of the present invention

FIG. 14 is a flowchart of a process used for performing a transaction with a customer in accordance with a preferred embodiment of the present invention;

FIG. 15 is a flowchart of a process used for processing user information at a secondary server in accordance with a preferred embodiment of the present invention;

FIG. 16 is a flowchart of a process used for processing new user information in accordance with a preferred embodiment of the present invention;

FIG. 17 is a flowchart of a process used for managing shopping carts in a Web commerce server system in accordance with a preferred embodiment of the present invention; and

FIG. 18 is a flowchart of a process for converting a shopping cart to a purchase order in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. Further, network data processing system 100 also includes server cluster 108 as well as a server 110. In this example, server 110 is connected to network 102 through local area network (LAN) 112. In addition, clients 114, 116, and 118 also are connected to network 102. These clients 114, 116, and 118 may be, for example, personal computers or network computers. In the depicted example, server 104, server cluster 108, and server 110 provide a distributed Web commerce server system for processing requests from clients 114-118. In the depicted examples, server 104, server cluster 108 and server 110 may be located in multiple, geographically distributed sites. The servers are presented to users, such as those at clients 114-118, as a single Web site. Additionally, one of the servers, such as server 104 may act as a load balancer to receive and direct requests from the clients to the appropriate servers within the system. Network data processing system 100 may include additional servers, clients, and other devices not shown.

In the depicted examples, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

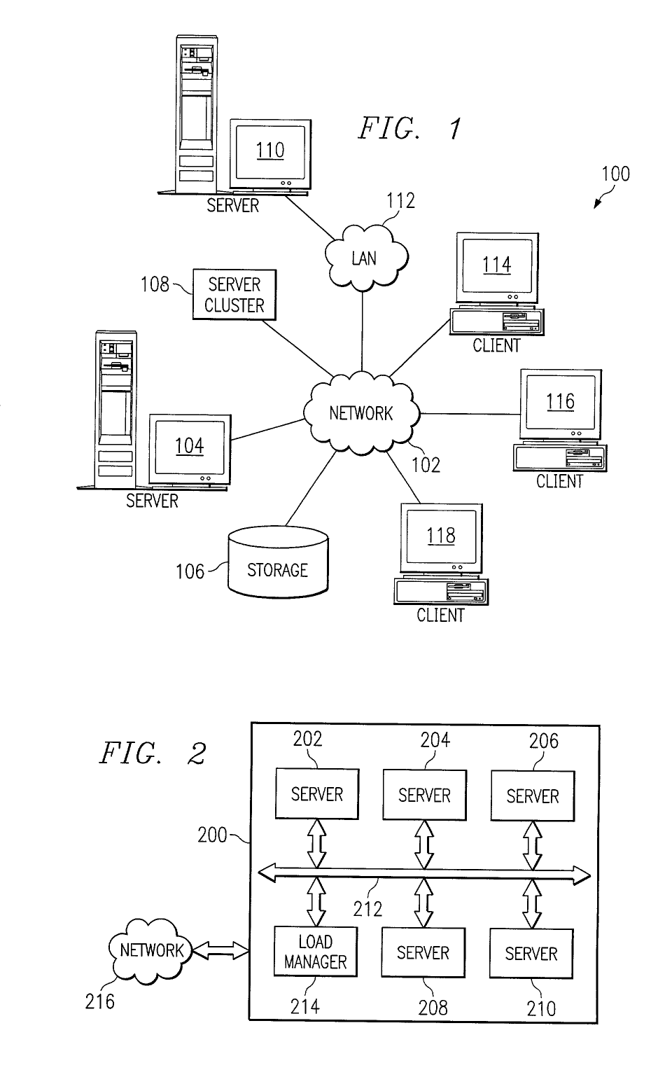

With reference now to FIG. 2, a block diagram of a server cluster is depicted in accordance with a preferred embodiment of the present invention. Server cluster 200 in this example may be implemented as server cluster 108 in FIG. 1.

In this example, servers 202-210 are in communication with each other through communications system 212, which may take various forms. Communications system 212 may be, for example, a bus, a network, or a shared memory. Communications system 212 is used to handle routing of requests and responses directed towards server cluster 200. Load manager 214 also is connected to communications system 212 and serves to receive requests directed to server cluster 200 from network 216. Load manager 214 also serves to distribute requests to servers 202-210 for processing.

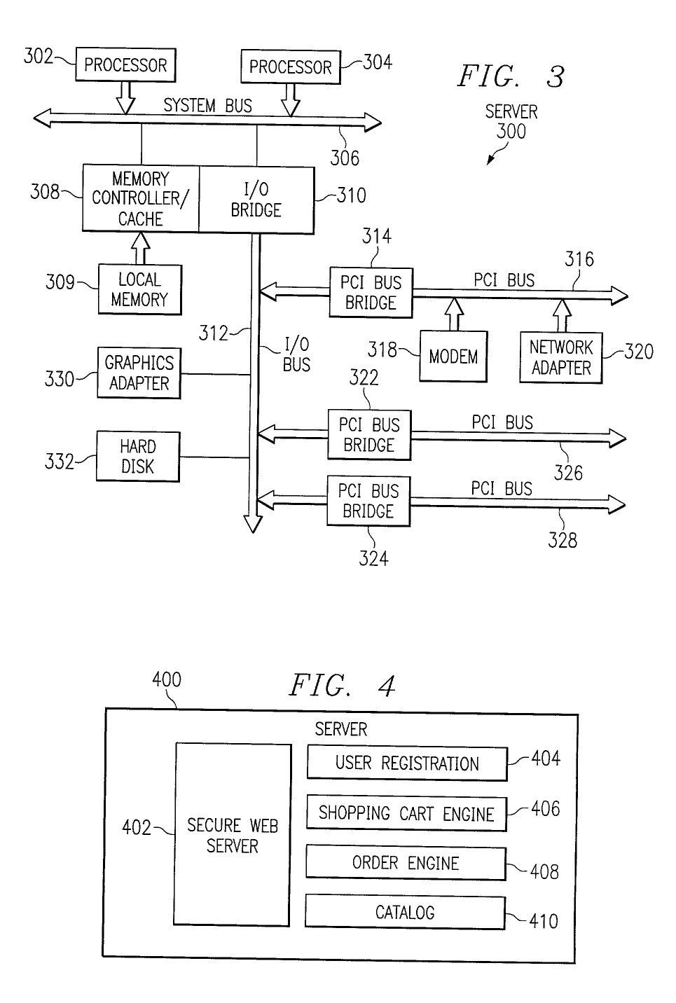

Referring to FIG. 3, a block diagram of a data processing system that may be implemented as a server, such as server 104 in FIG. 1, is depicted in accordance with a preferred embodiment of the present invention. Further, data processing system 300 may be implemented as a server, such as server 202 within server cluster 200, in FIG. 2.

Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and 1/0 bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to network 102 in FIG. 1 maybe provided through modem 318 and network adapter 320 which are connected to PCI local bus 316 through add-in boards.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIGS. 1-3 may vary. For example, in FIG. 1, additional clients or servers may be connected to network 102 other than those illustrated. In FIG. 2, server cluster 200 may include more or less servers that those illustrated. In FIG. 3, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM e-Server pSeries system, a product of International Business Machines Corporation in Armonk, N.Y., running the Advanced Interactive Executive (AIX) operating system or LINUX operating system.

Turning next to FIG. 4, a diagram illustrating components used in a Web commerce server is depicted in accordance with a preferred embodiment of the present invention. In this example, server 400 hosts Web commerce system processes, which may be accessed across the Internet. In particular, these processes are used to facilitate electronic commerce or e-commerce. E-commerce involves doing business online, typically via the Web. E-commerce also is called “e-business,” “e-tailing” and “I-commerce.”

As illustrated, server 400 includes a secure Web server 402, which is used to receive and process requests for information and purchase orders. In this example, secure Web server 402 uses various known encryption techniques to provide privacy and security for buyers ordering items. Secure Web server 402 sends received requests to appropriate components, such as user registration 404, shopping cart engine 406, order engine 408, and catalog 410 for processing. Additionally, secure Web server 402 will receive results and format those results for return to the originator of the request. In these examples, the requests are received in an HTTP format and placed in the appropriate form for use by other components in server 400. Further, secure Web server 402 will reformat the responses from these components into the appropriate form for return to the requestor. Those of ordinary skill in the art will readily appreciate that protocols other than HTTP, such as IIOP, SOAP, or other protocols can be used for interaction between clients and servers.

User registration 404 is used to identify and register buyers who submit purchase orders. Catalog 410 in these examples is used to provide information, such as identification of items being sold as well as quantities and descriptions of these items. Shopping cart engine 406 allows a user to store or hold items identified through catalog 410 in a “shopping cart.”

Order engine 408 provides order handling processes to generate purchase orders from items placed in a shopping cart for a customer. Further, order engine 408 forwards purchase orders for items to a primary server within the Web commerce server system for processing.

The components shown in FIG. 4 are for illustrative purposes and not meant as limitations to the implementation of the present invention. Other components may be used in addition to or in place of the illustrated components for providing Web commerce services.

Turning now to FIG. 5, a Web commerce server system is depicted in accordance with a preferred embodiment of the present invention. Web commerce server (WCS) system 500 in this example, includes a load balancer/failure detector 502, a primary WCS 504, and a secondary WCS 506. Load balancer/failure detector 502 serves to receive requests from clients for distribution to other servers within WCS system 500 for processing. For example, load balancer/failure detector 502 may receive a request from a buyer using Web browser 508 in client 510. Through Web browser 508, the buyer may receive information on items being offered in WCS system 500 as well as submit orders for those items.

WCS system 500 employs processes, computer implemented instructions, and apparatus for a distributed Web commerce service system, which may be located across multiple geographically distributed sites.

In this example, primary WCS 504 is the primary server and on failure of the primary server, a back-up server, such as secondary WCS 506 may takeover as the primary server. Alternatively, another server may be elected as primary server or the remaining servers may continue operation without the functions of the primary server. In the latter case, secondary WCS 506 handles user requests based on the catalog and user information at the time of the failure of primary WCS 504, and either holds orders until the primary comes back up, or directly submits orders to a fulfillment system. A failure of the primary server is identified through the load balancer/failure detector in these examples. The detection of a failure may be identified through various mechanisms, such as polling the primary server or detecting a heartbeat generated by the primary server.

Primary WCS 504 includes a mechanism for pushing or propagating one or more catalogs to other distributed servers, such as secondary WCS 506. In a preferred embodiment of the present invention, the catalog is converted into an extensible markup language (XML) document. In the depicted examples, a reliable data push function is used to propagate the XML document to the other nodes. Additional functionality is provided at the distributed servers to receive the XML catalog, parse and transform the XML document, and populate the catalog at the distributed servers according to this information.

The present invention also provides a mechanism for partitioning the inventory of items in the catalog among the distributed servers. In the present invention, each item in the product catalog has a corresponding inventory of product instances available for purchase. For example, a portion of a set of items may be allocated to primary WCS 504, while the remaining portion is allocated to secondary WCS 506. In a preferred embodiment of the present invention, primary server 504 allocates inventory to each of the distributed servers within WCS system 500. In the depicted examples, an XML message is created identifying the item and inventory level, and is pushed to the appropriate servers.

Further, load balancer/failure detector 502 also provides a mechanism for routing customer Web requests among the different distributed servers, such as, for example, primary WCS 504 and secondary WCS 506. This routing of requests may be implemented using various mechanisms, such as round-robin routing among nodes; routing to a subset of the distributed sites under normal operation and under heavy load or failure, routing to additional distributed nodes; and a mechanism for adding new nodes to, or of dropping nodes from, the set of nodes.

Catalog information, such as prices, may be updated at primary WCS 504 and propagated to the distributed servers within WCS system 500. In a preferred embodiment, catalog updates are specified in an XML message, and a trigger monitor, or a business-to-business (B2B) delivery mechanism, is used to push the catalog updates to the distributed servers. In the event of a failure of one or more of the distributed servers, pending updates are held and propagated when the failed server or servers recover. For example, changes to a catalog may be sent from primary WCS 504 to secondary WCS 506.

In WCS system 500, primary WCS 504 and each secondary WCS 506 has its own database. Additionally, in WCS system 500, a “shopping cart” is created in the database of a WCS, such as secondary WCS 506, when a user first indicates that an item is present in the catalog that the user wishes to purchase. As additional items are selected as indicated by the user, the database in the WCS is updated to include those items in that user's “shopping cart”. When the user indicates to the WCS that the user is done shopping and wants the order to be submitted, the database in the WCS is modified such that the “shopping cart” becomes an order. In a preferred embodiment, the status field in the relevant record is updated from “I”, which in WCS stands for “shopping cart in process”, to “C”, which in WCS stands for “order ready for fulfillment”. Of course, other mechanisms may be used to handle selections of items and purchases.

Load balancer/failure detector 502 assigns a particular shopper to a particular WCS for an extended period of time. For example, one or two hours may be used. During that period of time, any shopping cart creation and/or updating is performed by that same WCS. A user who does not interact with that WCS for more than one hour may be assigned a different WCS the next time the user sends a request through load balancer/failure detector 502. In the depicted examples, a correct and up-to-date shopping cart is ensured for that user to be available at that (possibly different) WCS. The mechanism of the present invention copies all active shopping carts to every WCS to which its users might be assigned by load balancer/failure detector 502. For example, a shopping cart created at secondary WCS 506, also may be copied to primary WCS 504 if it is possible that the user request may be directed to the primary WCS 504 by load balancer/failure detector 502. This copying of shopping carts may not occur with all other WCSs because the load balancer/failure detector 502 may not distribute all of the users to all of the WCSs. For example, each user, based on some identifying characteristic, like its IP address, may be assigned only to a particular subset of the WCSs.

In the depicted examples, a process is executing on each WCS to periodically check the database for shopping carts that have been created or updated since the last time the process performed such a check. This process may be implemented, for example, by defining a database trigger that inserts in another database table, such as a trigger table, a record indicating such an event had occurred. The monitoring process reads this table to see what events have occurred since the last time the process ran its cycle. A copy of each such updated or newly created shopping cart is sent (possibly in the form of cXML), to every relevant WCS. Each WCS also includes a process that waits for arrival of such a shopping cart and inserts the shopping cart into its own database upon arrival. The relevant record in the trigger table may be deleted at this time. A record of which shopping carts have been copied is kept at all sites that have such copies. When a shopping cart turns into a purchase order, this record is checked. If this check indicates that the shopping cart was previously copied, either into or out of this WCS, then this WCS informs the other WCSs of this change of status as well. The frequency of this checking and copying are such, in these examples, that any actions performed by the user assigned to one WCS will be available at any relevant WCS prior to the user's reassignment by the load balancer. If, for example, the load balancer will reassign users after one hour of idleness, this checking and copying is performed more than once. This process prevents the user from seeing the order, finalized on one WCS, turning back into a shopping cart when viewed on another WCS.

One optimization may be made when a secondary WCS informs the primary WCS that the primary WCS will be receiving the completed purchase order. In that case, the notification of this transition from shopping cart to order can be part of the originally discussed transfer of the completed purchase order. While we have described the case in which inventory for each secondary WCS is tracked at that server, those of ordinary skill in the art will readily appreciate that the inventory may be tracked at the primary node on behalf of all secondary servers and, during the order processing steps, the inventory would be decremented at the primary.

Additionally, inventory may be reallocated between the different servers within WCS system 500. For example, if secondary WCS 506 is low in inventory, secondary WCS 506 creates an XML message for additional inventory allocation and sends this message to the primary WCS 504 using a B2B delivery mechanism. In response, primary WCS 504 returns an XML message with the requested or other inventory, or indicates unavailability of inventory, to the requesting site. The basic assumption is that all user information will be available at all WCSs to which a particular user's requests might be sent. One way to provide this availability is to use a simple round-robin scheme, where all information must go everywhere.

In these examples, purchase orders (POs) generated at a server are sent to primary WCS 504 for final processing. In a preferred embodiment of the present invention, purchase transactions are executed at the distributed sites, based on inventory information available at the distributed sites. In other words, the customer selection and the transaction involved in finalizing the details of the purchase are handled or performed by secondary WCS 506. Then, asynchronously, the PO is formatted as XML message and sent to primary WCS 504 using a B2B delivery mechanism.

The present invention also provides a mechanism for distributing user information to the distributed sites from the primary server, or from a secondary server to the primary and other distributed servers. In a preferred embodiment, when a new distributed server is added, the primary server distributes user information, such as user or organization ids, passwords, and other user/customer information, to the distributed site. New user information is propagated from the server at which it originates to the primary server; the primary server determines which servers need to have this information, and propagates the information to those servers.

In the depicted examples in FIG. 5, only two servers are shown for purposes of illustration. Of course, additional servers may be employed within WCS system 500 depending on the particular implementation.

Turning next to FIG. 6, a flowchart of a process used for sending a catalog to a secondary server is depicted in accordance with a preferred embodiment of the present invention. The process illustrated in FIG. 6 may be implemented in a primary server, such as primary WCS 504 in FIG. 5.

The process begins receiving a catalog or an update to a catalog (step 600). In this example, the catalog may be a new catalog or an update to the catalog. For example, the update to the catalog may be a price change for an item in the catalog or a new item for insertion into the catalog. Next, the catalog is converted to an XML document (step 602). The catalog or update may be converted into other markup languages or other formats depending on the particular implementation. The converted catalog or update is then stored (step 604). Then, the process waits for a trigger event (step 606). The trigger event may take different forms. For example, the event may be based on a particular time or expiration of a timer. Alternatively, this trigger event may be in response to a request from a server. When the trigger event occurs, the converted XML document is sent to designated servers (step 608). A determination is made as to whether a confirmation is received from the servers to which the catalog or update is sent (step 610).

If a confirmation is received, the process terminates. Otherwise, the catalog or update is held for later distribution (step 612) with the process terminating thereafter. This process, in FIG. 6, may be employed to dynamically update catalogs at distributed locations within a WCS system.

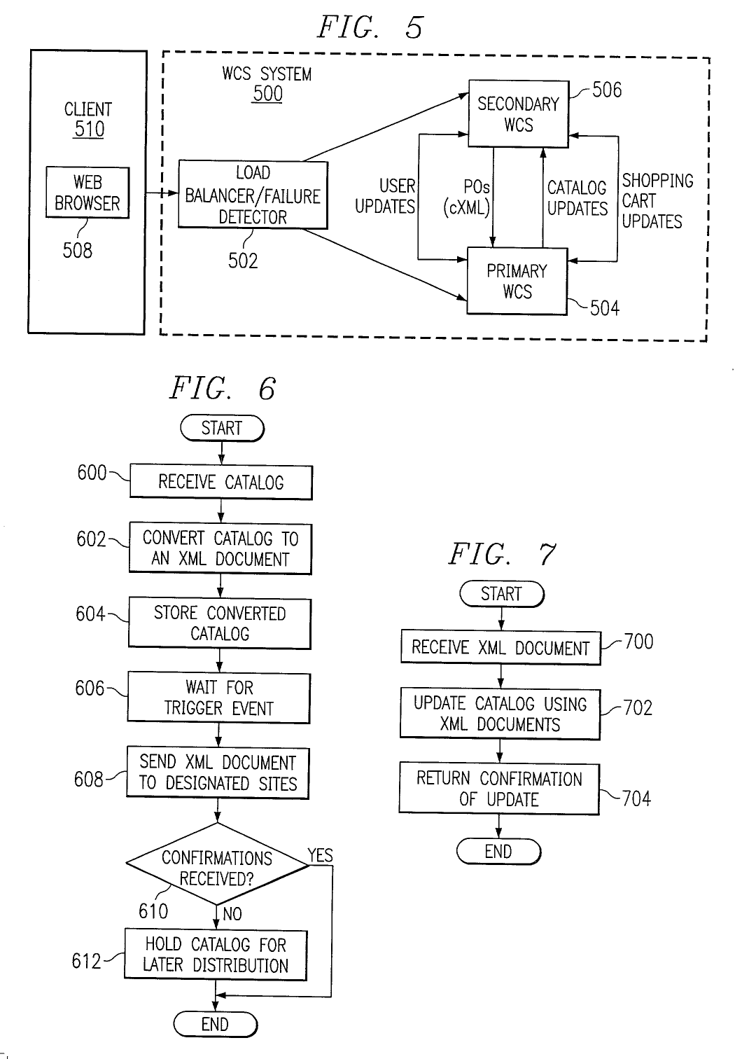

Turning next to FIG. 7, a flowchart of a process used for receiving a catalog at a secondary server is depicted in accordance with a preferred embodiment of the present invention. The process illustrated in FIG. 7 may be implemented in a secondary server, such as secondary WCS 506 in FIG. 5.

The process begins by receiving an XML document containing a catalog or an update to the catalog (step 700). This document is received from a primary server, which pushes catalogs or updates to the different secondary servers. The catalog is then updated using the XML document (step 702). This update may involve replacing the current catalog or making changes to the current catalog. A confirmation of the update is returned to the primary server (step 704) with the process terminating thereafter. The confirmation is used to provide an indication to the primary server that the catalog has been received and processed.

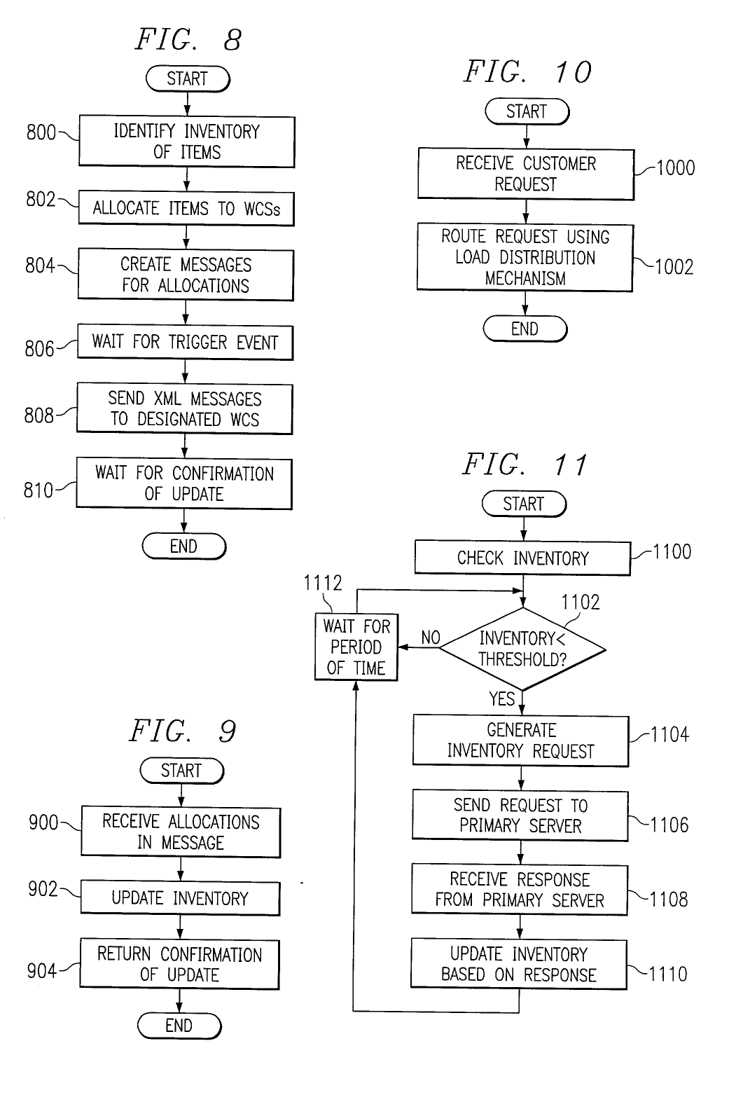

Turning now to FIG. 8, a flowchart of a process used for allocating items to servers within a Web commerce server system is depicted in accordance with a preferred embodiment of the present invention. The process illustrated in FIG. 8 may be implemented in a primary server, such as primary WCS 504 in FIG. 5.

The process begins with the identification of an inventory of items (step 800). The inventory items are then allocated to WCSs (step 802). The actual process used to allocate inventory may be implemented in many ways. For example, each server may be allocated an equal number of items. Alternatively, items may be allocated based on traffic at each server. Next, messages are created for allocations (step 804). In these examples, the messages are XML messages. The process waits for a trigger event (step 806). The trigger event may be the initial inventory allocation request, an update to the inventory becoming available at the primary WCS, or an inventory request from a secondary WCS (see FIG. 11, described below). In response to the triggered event, the XML messages are sent to the designated WCSs (step 808). Then, the user waits for the confirmation of an update from the secondary WCSs (step 810) with the process terminating thereafter.

Turning next to FIG. 9, a flowchart of a process used for receiving inventory allocations is depicted in accordance with a preferred embodiment of the present invention. The process illustrated in FIG. 9 may be implemented in a secondary server, such as secondary WCS 506 in FIG. 5.

The process begins by receiving allocations in a message (step 900). The message received takes the form of an XML message in these examples. Next, the inventory is updated (step 902). A confirmation of the updated inventory is returned to the primary server (step 904) with the process terminating thereafter.

Turning now to FIG. 10, a flowchart of a process used for handling a customer request is depicted in accordance with a preferred embodiment of the present invention. The process illustrated in FIG. 10 may be implemented in load balancer/failure detector 502 in FIG. 5.

The process begins by receiving a customer request (step 1000). The request is routed to the primary or secondary WCS server using a load distribution mechanism (step 1002) with the process terminating thereafter. This load distribution mechanism may take many forms as described above. In a preferred embodiment, a new user request, indicated by a source IP address and destination port different from one recorded by the load balancer, is routed to the least utilized primary or secondary server; and the load balancer records in a table the routing of the request from that source IP address and destination port (typically port 80) to the selected server. Subsequently, if another request is received from the same source IP address to the same destination port within a “stickiness” interval (e.g. 1 hour stickiness period), the load balancer detects this situation using the entry in the table and routes the client request to the same server that was previously selected for this source IP address and destination port. If no subsequent request is received from the same source IP address and destination port for the stickiness interval, the load balancer deletes the recorded routing information and a subsequent request from the same source IP address and destination port after the stickiness interval is routed to the then least utilized primary or secondary server. Those of ordinary skill in the art will readily appreciate that other methods for routing requests can be used by the load balancer. For example, the load balancer can be content aware and route a client request based on a cookie in the user request.

Turning now to FIG. 11, a flowchart of a process used for generating an inventory request is depicted in accordance with a preferred embodiment of the present invention. The process illustrated in FIG. 11 may be implemented in secondary WCS 506 in FIG. 5.

The process begins with a check for inventory (step 1100). Step 1100 identifies inventory present for one or more types of items. A determination is then made as to whether the inventory is less than a threshold (step 1102). This threshold may take various forms. For example, a threshold may be a percentage or a number of items. If the inventory is less than the threshold, the inventory request is generated (step 1104). In these examples, the request is put in an XML message. The request is then sent to a primary server (step 1106).

Next, a response is received from the primary server (step 1108). This response may include the request allocation, a portion of the requested allocation, or an indication that an allocation is not possible. The inventory is updated based on the response from the primary server (step 1110). The process then waits for a period of time (step 1112) with the process returning to step 1102 as described above. Turning back to step 1102, if the inventory is not less than the threshold, the process returns to step 1112 as described above. As mentioned earlier, those of ordinary skill in the art will readily appreciate that the inventory may be tracked at the primary node on behalf of all secondary servers and, during the order processing steps, the inventory would be decremented at the primary. In this case, the process illustrated in FIG. 11 would not be used.

Turning next to FIG. 12, a flowchart of a process used for handling a request for inventory is depicted in accordance with a preferred embodiment of the present invention. The process illustrated in FIG. 12 may be implemented in primary WCS 504 in FIG. 5.

The process begins by receiving a request for additional inventory (step 1200). The inventory levels are analyzed for the different servers (step 1202). Next, the inventory levels are reallocated to the requestor based on the analysis (step 1204). This reallocation may result in some servers losing items while other servers gaining items. Additionally, the reallocation could result in no changes at all. A reallocation message is generated for affected servers (step 1206). The reallocation messages are then sent to the affected servers (step 1208) with the process terminating thereafter.

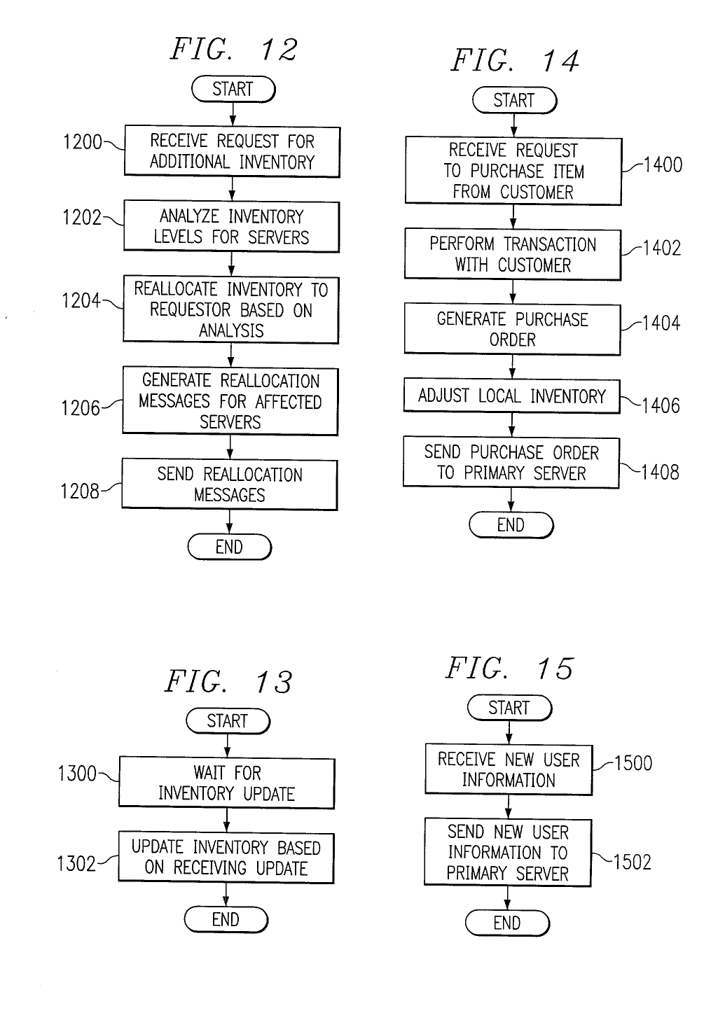

Turning next to FIG. 13, a flowchart of a process used for updating inventory at a server is depicted in accordance with a preferred embodiment of the present invention. The process illustrated in FIG. 13 may be implemented in a server, such as primary WCS 504 or secondary WCS 506 in FIG. 5.

The process begins by waiting for an inventory update (step 1300). Step 1300 may be implemented as a daemon process, which waits for an arrival of an unsolicited update to inventory allocated to the server on which this daemon process executes. Next, the inventory is updated based on the receipt of the inventory update (step 1302) with the process terminating thereafter.

With reference now to FIG. 14, a flowchart of a process used for performing a transaction with a customer is depicted in accordance with a preferred embodiment of the present invention. The process illustrated in FIG. 14 may be implemented in either a primary server or a secondary server, such as, for example, primary WCS 504 and secondary WCS 506 in FIG. 5.

The process begins with receiving a customer request to purchase an item (step 1400). In the depicted examples, the request is received from a load balancer node or computer, which forwards the request to the server. Next, a transaction is performed with the customer (step 1402). This transaction may include various processes, such as a selection of an item, identification of shipping, and the selection of a payment mechanism. A purchase order is generated (step 1404). The purchase order contains the information necessary to process the transaction at the primary server. Then, the local inventory is adjusted to take into account the items purchased (step 1406). Thereafter the purchase order is sent to the primary server (step 1408) with the process terminating thereafter.

Turning now to FIG. 15, a flowchart of a process used for processing user information at a secondary server is depicted in accordance with a preferred embodiment of the present invention. The process in FIG. 15 may be implemented in secondary WCS 506 in FIG. 5.

The process begins with a receipt of information from a new user (step 1500). This step is usually triggered when a new user visits the Web site hosted by the server. This information includes, for example, a user name and password. Then, the new user information is sent to the primary server (step 1502) with the process terminating thereafter. This information is sent to the primary server to allow for the new user information to be propagated to other servers within the system.

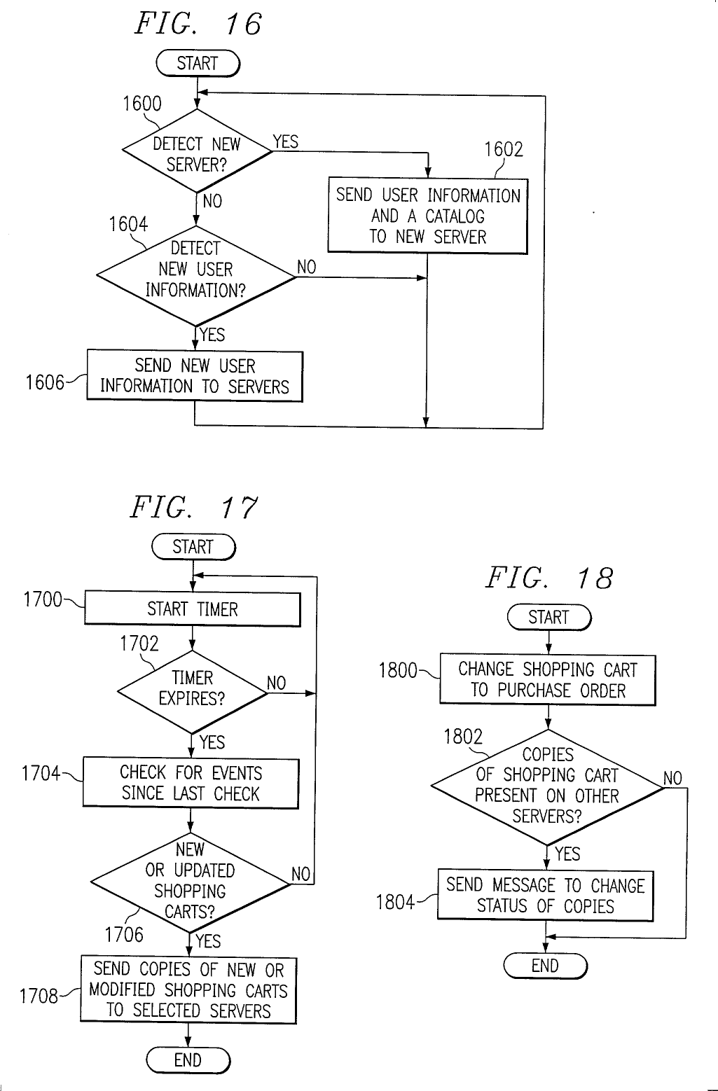

Turning next to FIG. 16, a flowchart of a process used for processing new user information is depicted in accordance with a preferred embodiment of the present invention. The process illustrated in FIG. 16 may be implemented in a primary server, such as primary WCS 504 in FIG. 5.

The process begins by determining whether a new server has been detected (step 1600). Typically, the new server is identified in response to a general broadcast message or a message specifically directed to the primary server. If a new server is detected, user information and a catalog is sent to the new server (step 1602) with the process returning to step 1600 as described above.

With reference again to step 1600, if a new server has not been detected, a determination is then made as to whether new user information has been detected (step 1604). This new user information is received from a server at which a user has registered. If new user information is received, this information is sent to the appropriate servers (step 1606) with the process returning to step 1600 as described above.

Returning to step 1604, if no new user information is detected, the process returns to step 1600 as described above. Note that, in a preferred embodiment, new user information is only sent from a secondary WCS to the primary WCS, or from the primary WCS to be distributed in step 1604, after a user has been inactive for the stickiness period, with a typical value of 60 minutes for the stickiness period. This prevents user information from being propagated very frequently, with consequent performance degradation.

Turning now to FIG. 17, a flowchart of a process used for managing shopping carts in a Web commerce server system is depicted in accordance with a preferred embodiment of the present invention. The process illustrated in FIG. 17 may be implemented in a server, such as primary WCS 504 or secondary WCS 506 in FIG. 5.

The process begins by starting a timer (step 1700). Next, a determination is made as to whether the timer has expired (step 1702). If the timer has not expired, the process returns to step 1702. Otherwise, a check is made for events occurring since the last check made by the process (step 1704). The check in step 1704 may be made by examining a table or other data structure in which events, such as the creation of a shopping cart or the updating of a shopping cart are logged. A determination is then made as to whether new or updated shopping carts are present (step 1706).

If additional shopping carts are not present, the process returns to step 1700 as described above. Otherwise, copies of the new or updated shopping carts are sent to selected servers (step 1708) with the process terminating thereafter. The servers are selected based on an identification of other servers to which requests made by the user may be routed. Further, the selected servers also include servers on which copies of the shopping carts already exist. The selected servers may also provide propagation of user information: information about each user of these systems, such as, for example, name, e-mail address, and password. With this propagation, the information may be created or updated at any time. To guarantee a consistent view of this information at all times, a mechanism similar to shopping carts may be used. In this situation, instead of a transition from a shopping cart to a purchase order, users only may open accounts, change accounts, and close the accounts.

With reference now to FIG. 18, a flowchart of a process for converting a shopping cart to a purchase order is depicted in accordance with a preferred embodiment of the present invention. The process illustrated in FIG. 18 may be implemented in a server, such as primary WCS 504 or secondary WCS 506 in FIG. 5.

The process begins by changing the shopping cart to a purchase order (step 1800). Thereafter, a determination is made as to whether copies of the shopping cart is present on other servers (step 1802). If copies of the shopping cart are present on other servers, then a message is sent to those servers to change the status of those copies (step 1804) with the process terminating thereafter. This step avoids the user seeing a shopping cart after deciding to purchase the items in the event that a user request is routed to one of these other servers by a load balancer. With reference again to step 1802, if copies are absent on the other server, the process terminates.

Although the depicted examples refer to a single catalog, some or all of the distributed servers may host multiple catalogs. For instance, each catalog may represent a different eCommerce site. Some of these nodes may be those of an offload site, or a recovery site. The load distribution can be extended to be based on service contracts and service level agreements (SLAs) with the offload sites.

Additionally, new distributed servers may be added dynamically to the WCS system. For example, if the load on a particular server is projected to increase, either for a special event, or for an extended period, an additional node can be added to the set of distributed servers for that catalog.

Thus, the mechanism of the present invention provides for scaling a commerce server system. Further, the mechanism of the present invention allows for routing or moving transactions to other portions of the network to reduce latency and offload processing from a primary site. Additionally, the mechanism of the present invention allows for disaster recovery if the primary site fails.

While the system and processes described herein include a single primary site, and one logical Web site, those skilled in the art will readily appreciate that the method and processes disclosed herein can be generalized to more than one primary site, which share one or more of the same secondary sites. In this case, each primary site may provide separate commerce sites, potentially Web sites for different companies. For each primary site, one or more secondary sites may be combined as described earlier. Thus, each secondary site would have all or part of the catalog, user, inventory and other data, for one or more primary sites; however, the secondary sites would logically separate this data for different primary sites.

While many of the processes have described using a single primary server, those skilled in the art will readily appreciate that the primary server function can be performed by more than one server, such as by a hierarchy of servers that function as primary servers to nodes that are in the sub-tree under that node.

Although the illustrated examples disclose a method in which orders are completed at the distributed site with purchase orders resulting from the completion being propagated to the primary server, other methods can be used. For example, all or some of the orders may be processed synchronously by sending the requests to the primary server, or by redirecting the order step to the primary server, such as by using a shopping cart embedded in a hidden field sent back to the browser and submitted to the primary site. Yet another way to handle the subsequent order fulfillment process is to determine an appropriate fulfillment server, such as, for example, based on geographic proximity, ordered items, etc.) and propagate this order to the fulfillment server. The selection process can be done by the distributed server in which the order is created or via a publish-subscribe mechanism to notify all interested servers.

While the depicted examples disclose a method in which the entire catalog is propagated to the distributed servers, partitions of the catalog may be propagated to different distributed servers. For example, the WCS system may support user groups, each of which have a private catalog, such as a separate user group could be set up for a specific company. These partitions of the catalog, such as a user group catalog, may be propagated to the distributed servers, or different partitions of the catalog may be propagated to different partitions of the distributed servers.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a primary data processing system for managing a catalog, the method comprising:
sending a catalog and user information to a plurality of secondary data processing systems located in a network data processing system;
allocating inventory associated with the catalog to the plurality of secondary data processing systems;
receiving an order from one of the plurality of secondary data processing systems; and
processing the order, in response to receiving the order.

2. The method of claim 1 further comprising:
sending an update to the catalog to the plurality of secondary data processing systems.

3. The method of claim 1 further comprising:
receiving a request to reallocate the inventory from a particular secondary data processing system within the plurality of secondary data processing systems;
identifying a reallocation of the inventory in response to receiving the request; and
sending messages to each secondary data processing system involved in the reallocation of the inventory.

4. The method of claim 3, wherein the request to allocate the inventory is received from the particular secondary data processing system upon a detection of a condition by the secondary data processing system.

5. The method of claim 4, wherein the condition is a threshold.

6. The method of claim 1 further comprising:
periodically obtaining necessary shopping cart data from at least one secondary data processing system within the plurality of secondary data processing systems; and
forwarding the necessary shopping cart data to other secondary data processing systems within the plurality of secondary data processing systems.

7. The method of claim 4, wherein a secondary data processing system within the plurality of secondary data processing systems periodically obtains necessary shopping cart data from a particular secondary data processing system within a plurality of secondary data processing systems; and forwards the necessary shopping cart data to other secondary data processing systems within the plurality of secondary data processing systems.

9. The method of claim 1, wherein the catalog is sent in a markup language document.

10. The method of claim 9, wherein the markup language is extensible markup language.

11. The method of claim 1 further comprising:
detecting a presence of another secondary data processing system; and
sending the catalog to the another secondary data processing system in response to detecting the presence.

12. The method of claim 1, wherein the plurality of secondary data processing systems are located within a network data processing system.

13. The method of claim 12, wherein the network data processing system is at least one of a wide area network, an intranet, and the Internet.

14. The method of claim 1, wherein the catalog is a first catalog, the inventory is a first inventory, and further comprising:
sending a second catalog to a second plurality of secondary data processing systems; and
allocating the second inventory to be associated with the second catalog to the second plurality of secondary data processing systems.

15. The method of claim 14, wherein a particular item is present in the first catalog and the second catalog.

16. The method of claim 14, wherein a selected secondary server is part of the first plurality of secondary servers and the second plurality of secondary servers.

17. A system for processing commercial transactions of a user over a large geographic area comprising:
a network;
a primary computing node connected to the network;
a plurality of secondary computing nodes connected to the network, each of the plurality of secondary computing nodes being located at a set of geographic sites;
a plurality of product inventories, each of the plurality of product inventories being associated with one of the plurality of geographic sites; and
a catalog of products, wherein the catalog identifies the plurality of product inventories,
wherein the primary computing node notifies the plurality of secondary computing nodes of updates to the catalog, a user contacts a first node from the plurality of secondary computing nodes, the user places a product order with the first node, the first node forwards the order to the primary computing node, and the order is processed by the primary computing node.

18. The system of claim 17, wherein the primary computing node notifies the plurality of secondary computing nodes of the updates to the catalog by sending catalog data encoded in extensible markup language.

19. The system of claim 17, wherein the user is directed to the first node according to a load-balancing scheme.

20. The system of claim 17 wherein the primary computing node:
periodically obtains necessary shopping cart data from at least one secondary data processing system within the plurality of secondary data processing systems to primary data processing system; and
forwards the necessary shopping cart data to other secondary data processing systems within the plurality of secondary data processing systems.

21. The system of claim 19, wherein the load-balancing scheme is round-robin routing.

22. The system of claim 19, wherein the load-balancing scheme is to direct the user to one of a subset of the plurality of secondary computing nodes under normal operation and to direct the user to one of the entire plurality of secondary computing nodes when the system is under heavy load or when one of the plurality of secondary computing nodes has failed.

23. The system of claim 17, wherein the first node sends a request to the primary computing node to change an inventory for the first node.

24. The system of claim 17, wherein the user is directed towards the first node by a load balancing node implementing a load balancing scheme, wherein the load balancing node receives all user requests directed towards the system.

25. The system of claim 17, wherein the primary computing node dynamically propagates changes to the catalog to the plurality of secondary computing nodes.

26. The system of claim 17, wherein the primary computing node is a first primary computing node and further comprising a second primary computing node.

27. The system of claim 26, wherein the catalog is a first catalog, the first primary computing node manages the first catalog, and the second primary computing node manages a second catalog.

28. The system of claim 17, wherein orders are processed synchronously by the primary server.

29. The system of claim 17, wherein the order is received at the first node and forwarded to the primary computing node from the first computing node.

30. A system for processing commercial transactions of a user over a large geographic area comprising:
a network;
a primary computing node connected to the network;
a plurality of secondary computing nodes connected to the network, each of the plurality of secondary computing nodes being located at a set of geographic sites;
a plurality of product inventories, each of the plurality of product inventories being associated with one of the plurality of geographic sites; and
a catalog of products, wherein the catalog identifies the plurality of product inventories,
wherein the primary computing node notifies the plurality of secondary computing nodes of updates to the catalog, a user contacts a first node from the plurality of secondary computing nodes, the user places a product order with the first node, the first node forwards the order to a selected node to process the order based on selected criteria.

31. The system of claim 30, wherein the selected criteria is at least one of a geographic proximity, and a number of ordered items.

32. The system of claim 30, wherein the selected node is selected from one of the primary computing node and one of the plurality of secondary computing nodes.

33. A data processing system for managing a catalog, the data processing system comprising:
sending means for sending a catalog and user information to a plurality of secondary data processing systems located in a network data processing system;
allocating means for allocating inventory associated with the catalog to the plurality of secondary data processing systems;
receiving means for receiving an order from one of the plurality of secondary data processing systems; and
processing means for processing the order, in response to receiving the order.

34. The data processing system of claim 33, wherein the sending means is a first sending means and further comprising:
second sending means for sending an update to the catalog to the plurality of secondary data processing systems.

35. The data processing system of claim 33, wherein the receiving means is a first receiving means, the sending means is a first sending means and further comprising:
second receiving means for receiving a request to reallocate the inventory from a particular secondary data processing system within the plurality of secondary data processing systems;
identifying means for identifying a reallocation of the inventory in response to receiving the request; and
third sending means for sending messages to each secondary data processing system involved in the reallocation of the inventory.

36. The data processing system of claim 35, wherein the request to allocate the inventory is received from the particular secondary data processing system upon a detection of a condition by the secondary data processing system.

37. The data processing system of claim 36, wherein the condition is a threshold.

38. The data processing system of claim 33 further comprising:
obtaining means for periodically obtaining necessary shopping cart data from at least one secondary data processing system within the plurality of secondary data processing systems to primary data processing system; and
forwarding means for forwarding the necessary shopping cart data to other secondary data processing systems within the plurality of secondary data processing systems.

39. The data processing system of claim 38, wherein a secondary data processing system within the plurality of secondary data processing systems periodically obtains necessary shopping cart data from a particular secondary data processing system within a plurality of secondary data processing systems; and forwards the necessary shopping cart data to other secondary data processing systems within the plurality of secondary data processing systems.

40. The data processing system of claim 33, wherein the catalog is sent in a markup language document.

41. The data processing system of claim 33, wherein the markup language is extensible markup language.

42. The data processing system of claim 33, wherein the sending means is a first sending means and further comprising:
detecting means for detecting a presence of another secondary data processing system; and
fourth sending means for sending the catalog to the another secondary data processing system in response to detecting the presence.

43. The data processing system of claim 33, wherein the plurality of secondary data processing systems are located within a network data processing system.

44. The data processing system of claim 43, wherein the network data processing system is at least one of a wide area network, an intranet, and an Internet.

45. The data processing system of claim 33, wherein the catalog is a first catalog, the inventory is a first inventory, the sending means is a first sending means, the allocating means is a first allocating means and further comprising:
fifth sending means for sending a second catalog to a second plurality of secondary data processing systems; and
second allocating means for allocating the second inventory to associated with the second catalog to the second plurality of secondary data processing systems.

46. The data processing system of claim 45, wherein a particular item is present in the first catalog and the second catalog.

47. The data processing system of claim 45, wherein a selected secondary server is part of the first plurality of secondary servers and the second plurality of secondary servers.

48. A computer program product in a computer readable medium for managing a catalog, the computer program product comprising:
first instructions for sending a catalog and user information to a plurality of secondary data processing systems located in a network data processing system;
second instructions for allocating inventory associated with the catalog to the plurality of secondary data processing systems;
third instructions for receiving an order from one of the plurality of secondary data processing systems; and
fourth instructions for processing the order, in response to receiving the order.

49. The computer program product of claim 48 further comprising:
fifth instructions for sending an update to the catalog to the plurality of secondary data processing systems.

50. The computer program product of claim 48 further comprising:
fifth instructions for receiving a request to reallocate the inventory from a particular secondary data processing system within the plurality of secondary data processing systems;
sixth instructions for identifying a reallocation of the inventory in response to receiving the request; and
seventh instructions for sending messages to each secondary data processing system involved in the reallocation of the inventory.

51. The computer program product of claim 50, wherein the request to allocate the inventory is received from the particular secondary data processing system upon a detection of a condition by the secondary data processing system.

52. The computer program product of claim 51, wherein the condition is a threshold.

53. The computer program product of claim 48 further comprising:
fifth instructions for periodically obtaining necessary shopping cart data from at least one secondary data processing system within the plurality of secondary data processing systems to primary data processing system; and
sixth instructions for forwarding the necessary shopping cart data to other secondary data processing systems within the plurality of secondary data processing systems.

54. The computer program product of claim 53, wherein a secondary data processing system within the plurality of secondary data processing systems periodically obtains necessary shopping cart data from a particular secondary data processing system within a plurality of secondary data processing systems; and forwards the necessary shopping cart data to other secondary data processing systems within the plurality of secondary data processing systems.

55. The computer program product of claim 48, wherein the catalog is sent in a markup language document.

56. The computer program product of claim 55, wherein the markup language is extensible markup language.

58. The data processing system of claim 48 further comprising:
fifth instructions for detecting a presence of another secondary data processing system; and
sixth instructions for sending the catalog to the another secondary data processing system in response to detecting the presence.

59. The computer program product of claim 48, wherein the plurality of secondary data processing systems are located within a network data processing system.

60. The computer program product of claim 59, wherein the network data processing system is at least one of a wide area network, an intranet, and an Internet.

61. The computer program product of claim 48, wherein the catalog is a first catalog, the inventory is a first inventory, and further comprising:
fifth instructions for sending a second catalog to a second plurality of secondary data processing systems; and
sixth instructions for allocating the second inventory to associated with the second catalog to the second plurality of secondary data processing systems.

62. The computer program product of claim 61, wherein a particular item is present in the first catalog and the second catalog.

63. The computer program product of claim 61, wherein a selected secondary server is part of the first plurality of secondary servers and the second plurality of secondary servers.

64. A data processing system comprising:
a bus system;
a communications unit connected to the bus system;
a memory connected to the bus system, wherein the memory includes as set of instructions; and
a processing unit connected to the bus system, wherein the processing unit executes the set of instructions to send a catalog to a plurality of secondary data processing systems located in a network data processing system; allocate inventory associated with the catalog to the plurality of secondary data processing systems; receive an order from one of the plurality of secondary data processing systems; and process the order, in response to receiving the order.

65. The data processing system of claim 64, wherein the processor further executes the set of instructions to send an update to the catalog to the plurality of secondary data processing systems.

66. The data processing system of claim 64, wherein the processor further executes the set of instructions to receive a request to reallocate the inventory from a particular secondary data processing system within the plurality of secondary data processing systems; identify a reallocation of the inventory in response to receiving the request; and send messages to each secondary data processing system involved in the reallocation of the inventory.

67. The data processing system of claim 64 wherein the processor further executes the set of instructions to periodically obtain necessary shopping cart data from at least one secondary data processing system within the plurality of secondary data processing systems to primary data processing system; and forwards the necessary shopping cart data to other secondary data processing systems within the plurality of secondary data processing systems.

68. The data processing system of claim 64, wherein the catalog is sent in a markup language document.

69. The data processing system of claim 68, wherein the markup language is extensible markup language.

70. The data processing system of claim 64, wherein the processor further executes the set of instructions to detect a presence of another secondary data processing system; and send the catalog to the another secondary data processing system in response to detecting the presence.

71. The data processing system of claim 64, wherein the plurality of secondary data processing systems are located within a network data processing system.

72. The data processing system of claim 71, wherein the network data processing system is at least one of a wide area network, an intranet, and an Internet.

73. The data processing system of claim 64, wherein the catalog is a first catalog, the inventory is a first inventory and the processor further executes the set of instructions to send a second catalog to a second plurality of secondary data processing systems; and allocate the second inventory to associated with the second catalog to the second plurality of secondary data processing systems.

74. The data processing system of claim 73, wherein a particular item is present in the first catalog and the second catalog.

75. The data processing system of claim 73, wherein a selected secondary server is part of the first plurality of secondary servers and the second plurality of secondary servers.
